(19) United States
(12) Patent Application Publication
(10) Pub. No.: US 2026/0132649 A1
(43) Pub. Date: May 14, 2026

(54) POOL CLEANER WITH ARM ASSEMBLY

(71) Applicant: ZODIAC POOL CARE EUROPE, Belberaud (FR)

(72) Inventors: Simon Duffaut, Castelginest (FR); Louis Favié, Colomiers (FR); Rémi Deloche, Toulouse (FR)

(73) Assignee: ZODIAC POOL CARE EUROPE, Belberaud (FR)

(21) Appl. No.: 19/384,168

(22) Filed: Nov. 10, 2025

Related U.S. Application Data
(60) Provisional application No. 63/719,094, filed on Nov. 11, 2024.

(51) Int. Cl. E04H 4/16; C02F 1/00; C02F 103/42; H02S 10/20

(52) U.S. Cl. CPC E04H 4/1654; C02F 1/001; H02S 10/20; C02F 2103/42; C02F 2201/009; C02F 2209/008

(57) ABSTRACT

A pool cleaner for a swimming pool or spa generally includes a body and an arm assembly. The arm assembly is connected to the pool cleaner such that the arm assembly is movable between a stowed configuration and a deployed configuration. In the deployed configuration, the arm assembly extends forward from a front end of the body. The arm assembly comprises a supplemental component providing supplemental functionality to the arm assembly.

### REFERENCE TO RELATED APPLICATION

This application claims the benefit of and priority to U.S. Provisional Patent Application No. 63/719,094, filed on Nov. 11, 2024, and entitled POOL CLEANER WITH MOBILE HANDLE, the content of which is hereby incorporated by reference in its entirety.

### FIELD OF THE INVENTION

The invention relates to swimming pool cleaners for cleaning water-containing vessels such as swimming pools and spas.

### BACKGROUND OF THE INVENTION

Numerous cleaning devices capable of self-propelled autonomous or semi-autonomous movement within swimming pools and spas currently exist. The most common of these devices are automatic swimming pool cleaners, which often are either hydraulic pool cleaners or robotic pool cleaners. Hydraulic pool cleaners vary water flow for movement, while robotic pool cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. Pool cleaners may require periodic service or maintenance, such as to clean, replace, and/or otherwise service a filter of the pool cleaner. Commonly, a pool cleaner may move to a water line of the pool, and an end user must remove the pool cleaner from the pool to service the pool cleaner. For example, an end user may need to lean or bend towards the water line and lift the water-logged pool cleaner from the water, but such movement may be inconvenient and/or may be a safety risk to the user attempting to lift the pool cleaner, and an erroneous movement by the user may injure the end user, cause the end user to fall into the pool, and/or may damage the pool cleaner.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool cleaner includes a body and an arm assembly. The arm assembly is connected to the pool cleaner such that the arm assembly is movable between a stowed configuration and a deployed configuration where, in the deployed configuration, the arm assembly extends forward from a front end of the body. The arm assembly includes a supplemental component providing supplemental functionality to the arm assembly.

According to some embodiments, a pool cleaner includes a body and an arm assembly with an end connected to the pool cleaner such that the arm assembly is movable between a stowed configuration and a deployed configuration. A portion of the arm assembly opposite from the end comprises a supplemental component providing supplemental functionality to the arm assembly.

According to various embodiments, a pool cleaner includes a body and an arm assembly connected to the pool cleaner such that the arm assembly is movable between a stowed configuration and a deployed configuration. The arm assembly comprises a human machine interface.

According to some embodiments, a pool cleaner includes a body and an arm assembly. The arm assembly is movably connected to the pool cleaner such that the arm assembly is movable between a stowed configuration and a deployed configuration, and the arm assembly includes an antenna for wireless communication.

According to certain embodiments, a pool cleaner includes a body and an arm assembly. The arm assembly is movably connected to the pool cleaner such that the arm assembly is movable between a stowed configuration and a deployed configuration, and the arm assembly includes a sensor.

According to various embodiments, a pool cleaner includes a body and an arm assembly movably connected to the pool cleaner such that the arm assembly is movable between a stowed configuration and a deployed configuration, and the arm assembly includes a powering component.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system with a pool cleaner having an arm assembly according to embodiments.

FIG. 2 illustrates the pool cleaner of FIG. 1 on a wall of the pool of the pool system.

FIGS. 3A-C illustrate deployment of the arm assembly of the pool cleaner of FIG. 1 according to embodiments.

FIG. 4 illustrates the pool cleaner of FIG. 1 with the arm assembly in the deployed configuration according to embodiments.

FIG. 5 illustrates the pool cleaner of FIG. 1 with the arm assembly in the deployed configuration according to embodiments.

FIG. 6 illustrates the pool cleaner of FIG. 1 with the arm assembly in the deployed configuration according to embodiments.

FIG. 7 illustrates the pool cleaner of FIG. 1 with the arm assembly in the deployed configuration according to embodiments.

FIG. 8 illustrates the pool cleaner of FIG. 1 with the arm assembly in the deployed configuration according to embodiments.

FIG. 9 illustrates a user removing a front extraction filter from the pool cleaner of FIG. 1

FIG. 10 illustrates a user removing the pool cleaner of FIG. 1 from the pool and handling the pool cleaner according to embodiments.

FIG. 11 illustrates the pool system of FIG. 1 additionally including a docking station.

FIG. 12 illustrates the pool cleaner of FIG. 1.

FIG. 13 illustrates the pool cleaner of FIG. 1.

FIG. 14 illustrates the pool cleaner of FIG. 1 with a docking station.

FIG. 15 illustrates the pool cleaner of FIG. 1 with a docking station.

FIG. 16 illustrates the pool cleaner of FIG. 1 with a docking station.

FIG. 17 illustrates the pool cleaner of FIG. 1 with a docking station.

FIG. 18 illustrates the pool cleaner of FIG. 1 with a docking station.

### DESCRIPTION OF THE INVENTION

Described herein are self-propelled pool cleaners for swimming pools, spas, and other recreational water vessels which include an arm assembly. The arm assembly may be selectively stowed or deployed relative to a body of the pool cleaner. In a deployed configuration, the arm assembly may be utilized to support the pool cleaner at a water line of a pool and/or may be utilized by a user to transport and/or otherwise handle the pool cleaner (e.g., as a handle and/or as otherwise desired).

In certain embodiments, the arm assembly may be movable relative to the pool cleaner using various techniques or mechanisms as desired. As non-limiting examples, the arm assembly may be slidable, linearly movable, pivotable, rotatable, and/or otherwise movable relative to the pool cleaner between stowed and deployed configurations. In a non-limiting example, the arm assembly may be pivotably or rotatably connected to the pool cleaner such that the arm assembly may rotate between stowed and deployed configurations relative to a body of the pool cleaner. In the deployed configuration, the arm assembly may extend and/or project forward from a front end of the body of the pool cleaner. In certain embodiments, the arm assembly may be controlled to be in the deployed configuration when the pool cleaner is at a water line of the pool, and the arm assembly in the deployed configuration may engage a ground (or other) surface at least partially surrounding the pool (e.g., a pool deck) and support the pool cleaner at the water line.

In addition to providing temporary support to the pool cleaner, the arm assembly may provide improved functionality to the pool cleaner by incorporating various features or components in the arm assembly and/or by coordinating operation of the arm assembly with other operations of the pool cleaner. Including such features on the arm assembly may increase a number of features on the pool cleaner, provide alternative locations for components on the pool cleaner, and/or may allow for features to be retrofit with the pool cleaner. Non-limiting examples are described in further detail below.

In some embodiments, the arm assembly may include a human machine interface, such as but not limited to a light, a speaker, a screen, a microphone, a camera, a projector, a button, combinations thereof, and/or other features as desired. In such embodiments, the pool cleaner may receive information from and/or provide information to a user via the arm assembly even when a body of the pool cleaner may be partially submerged within the pool.

Additionally, or alternatively, the arm assembly may include an antenna for wireless communication. In such embodiments, the pool cleaner may wirelessly communicate with a remote device and/or a remote system using the arm assembly. In some embodiments, by including the antenna at least in the arm assembly, the antenna may be positioned for providing improved wireless communication, even if the body of the pool cleaner may be at a sub-optimal location for communication. As a non-limiting example, the arm assembly may be partially or fully deployed such that the arm assembly (and antenna) are at or above a water line of the pool even if the body of the pool cleaner is partially or fully submerged.

Additionally, or alternatively, the arm assembly may include one or more sensors, such as but not limited to a camera, accelerometer, movement sensor, contact sensor, proximity sensor, water detection sensor, pressure sensor, light sensor, water sensor, temperature sensor, combinations thereof, and/or as otherwise desired. The one or more sensors on the arm assembly may be positioned to be at various locations relative to the body by causing movement of the arm assembly as desired, which may provide an improved ability by the sensors to obtain various information.

In some embodiments, the arm assembly optionally may include various devices or components associated with powering the pool cleaner and/or subcomponents thereof. Such powering components may include one or more devices for generating electrical energy, storing electrical energy, and/or charging. As non-limiting examples, the arm assembly may include one or more batteries (e.g., as a store of electrical energy), a solar panel (e.g., as a device generating electrical energy), a charging connector, such as but not limited to a charging port, a charging pad, and/or other charging feature for engaging a docking station, a charging cable, and/or a charging station, combinations thereof, and/or other powering components as desired.

In certain embodiments, the arm assembly optionally may include one or more features of a hydraulic circuit of the pool cleaner. As a non-limiting example, the arm assembly may include a filter for capturing debris and/or the arm assembly may be integrated with the filter of the pool cleaner. As one non-limiting example, the arm assembly may be integrated with a front extraction filter of the pool cleaner, or other filter of the pool cleaner.

Various other benefits and advantages may be realized with the systems, devices, and methods provided herein, and the aforementioned advantages should not be considered limiting.

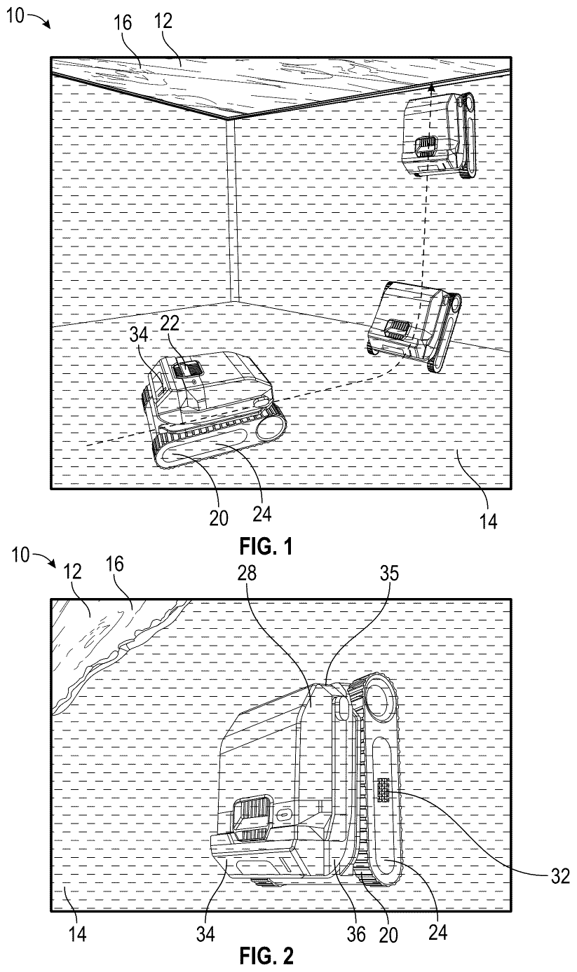

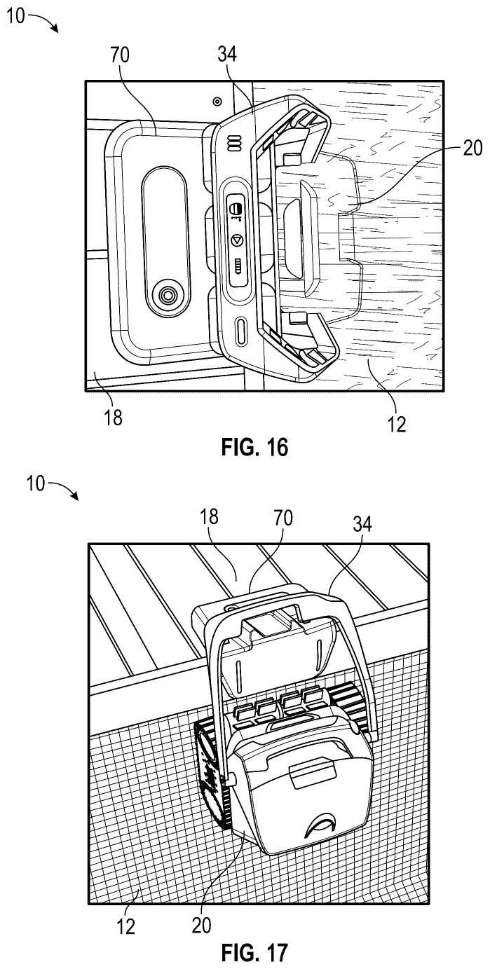

FIGS. 1-18 illustrate an example of a pool system 10 with a swimming pool or spa 12 (hereinafter “pool 12”). The pool 12 may have various shapes, sizes, and dimensions, as desired. In various embodiments, water 14 of the pool 12 includes a water line 16. A ground surface 18 may at least partially surround the pool 12.

In certain embodiments, the pool system 10 includes one or more self-propelled pool cleaners 20, which may be various types of cleaners capable of autonomous or semi-autonomous movement within the pool 12. As non-limiting examples, the pool cleaner 20 may be a robotic cleaner or a hydraulic cleaner as desired. Moreover, if the pool cleaner 20 is a robotic cleaner, it may be a cordless pool cleaner 20 (e.g., with an onboard battery) or a corded pool cleaner (e.g., connected to a device and/or external power source via a cable or cord) as desired.

The pool cleaner 20 includes a body 22 and one or more motive devices 24 for propelling the pool cleaner 20 within the pool 12 and along a surface. Non-limiting examples of motive devices 24 include, but are not limited to, wheels, tracks, rollers, feet, propellers, combinations thereof, and/or other suitable devices as desired.

The pool cleaner 20 generally includes one or more inlets for drawing water into the body 22 and one or more outlets for directing water from the pool cleaner 20. In some embodiments, the pool cleaner 20 may include one or more cleaning devices 26, such as but not limited to one or more brush assemblies, for dislodging debris, directing water towards the inlets, and/or otherwise facilitating a cleaning operation of the pool cleaner. Water may be directed through the body 22 from the one or more inlets, through a filter 28, and to the outlet such that debris-laden water may enter the filter, with the filter stopping or capturing at least some of the debris before allowing filtered water to exit.

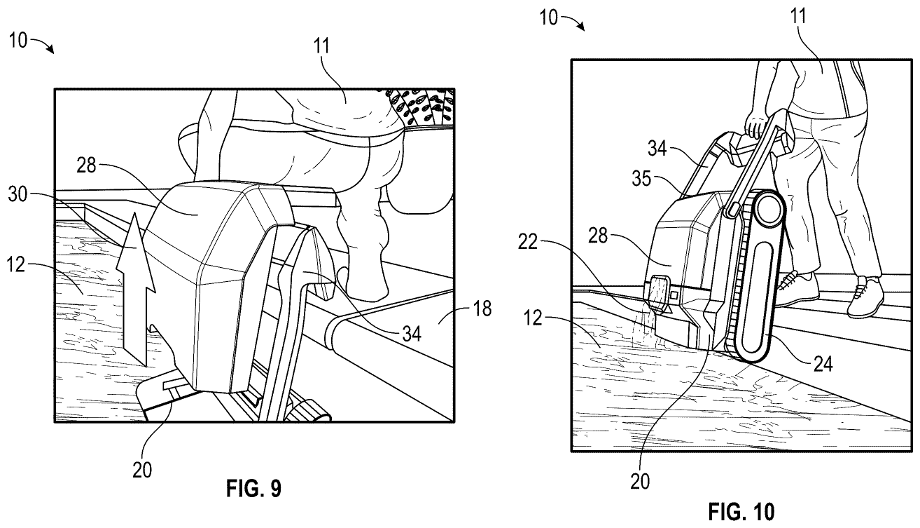

The filter 28 may be at least partially housed within the body 22. Optionally, a housing of the filter 28 may at least partially form an outer surface of the pool cleaner 20. The filter 28 may be various types of filters as desired. In a non-limiting example, and as illustrated in FIG. 9, the filter 28 may be a front extraction filter 28 which is removable from the body 22 in a direction away from a front end 35 of the body 22 (represented by arrow 30 in FIG. 9).

The pool cleaner 20 may include various additional components as desired, such as but not limited to one or more traction (or other) motors, one or more pumps, a control system 32 (e.g., processor and/or memory), one or more batteries (integrated or removable as desired), one or more sensors, a communication module enabling wired or wireless communication, combinations thereof, and/or various other components or combinations of components as desired.

The control system 32 of the pool cleaner 20 may include one or more processing units and/or one or more memory devices on and/or associated with the pool cleaner 20. In some embodiments, the control system 32 may be provided locally onboard the pool cleaner 20, while in other embodiments, the control system 32 may be remote from the pool cleaner 20. In embodiments where the control system 32 is remote, the control system 32 may be communicatively coupled to the pool cleaner 20 utilizing various communication techniques as desired, including wired and/or wireless communication. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels, and/or various other storage mediums capable of storing that contain or carry instruction(s) and/or data.

As mentioned, the pool cleaner 20 illustrated should not be considered limiting, and the pool cleaner 10 may have fewer, additional, or various other combinations of features as desired. Other non-limiting examples of pool cleaners 20 may include those described in U.S. Pat. Nos. 10,316,534, 9,488,154, 8,578,538, and U.S. Patent Publication No. 2014/0303810, all of which are hereby incorporated by reference in their entireties.

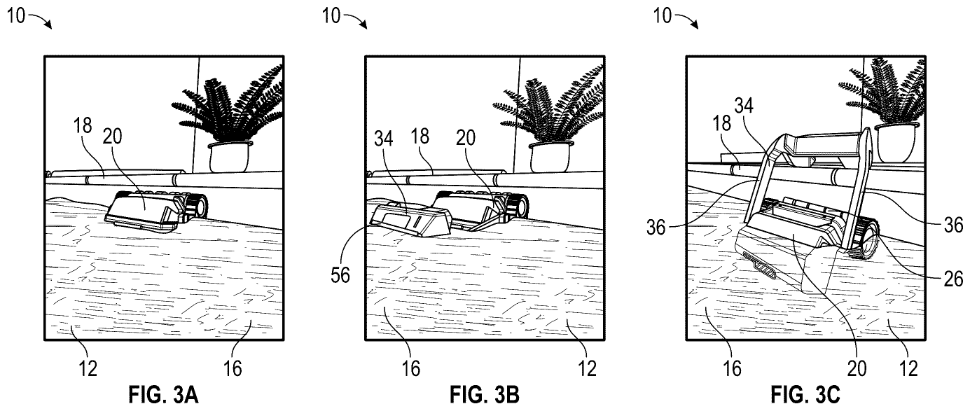

As illustrated in FIGS. 1-18, the pool cleaner 20 may include an arm assembly 34 which is movable relative to the body 22 of the pool cleaner 20. In certain embodiments, the arm assembly 34 is movably connected to the pool cleaner 20 such that the arm assembly 34 may move between a stowed configuration (see, e.g., FIG. 2) and a deployed configuration (see, e.g., FIG. 3C) and any position in between (see, e.g., FIG. 3B with the arm assembly 34 at an intermediate position). The arm assembly 24 may be movable relative to the body 22 using various techniques or mechanisms as desired. As non-limiting examples, the arm assembly 24 may be pivotably or rotatably connected to the pool cleaner 20 such that the arm assembly 24 pivots or rotates between stowed and deployed configurations. Additionally, or alternatively, the arm assembly 24 may be slidable relative to the pool cleaner 20, linearly movable relative to the pool cleaner 20, combinations thereof, and/or otherwise movable as desired. In certain embodiments, in the deployed configuration, the arm assembly 34 may extend forward from the front end 35 of the body 22. In the deployed configuration, the arm assembly 34 may be utilized to engage the ground surface 18 and support the pool cleaner 20 at the water line 16 and/or may be utilized by a user to lift and/or transport the pool cleaner 20.

The arm assembly 34 includes one or more arms 36. While FIGS. 1-18 illustrate the arm assembly 34 with two arms 36, in other embodiments, a pool cleaner 20 may include one arm 36, two arms 36, or more than two arms 36. The one or more arms 36 are configured to extend outwards from the pool cleaner in a deployed configuration. In embodiments with a plurality of arms 36, the arms 36 may be connected to or detached from each other as desired.

Each arm 36 includes at least one arm segment, such as one arm segment, two arm segments, three arm segments, etc. Such arm segments may be a one-piece construction and/or integrally formed (e.g., portions of a same component) and/or may be discrete components connected together using devices or mechanisms as desired. In a non-limiting example, each arm 36 includes a first arm segment 38 and a second arm segment 40. The first arm segment 38 may be the portion of the arm 36 pivotably connected to the pool cleaner 20, and the second arm segment 40 may extend from the first arm segment 38. In certain embodiments, the second arm segment 40 extends at a non-zero angle relative to the first arm segment 38. The second arm segment 40 extending at the non-zero angle relative to the first arm segment 38 may facilitate engagement of the arm assembly 34 with a surface and/or by a user. In other embodiments, arms 36 of the arm assembly 34 may have other configurations and/or arrangements of arm segments as desired.

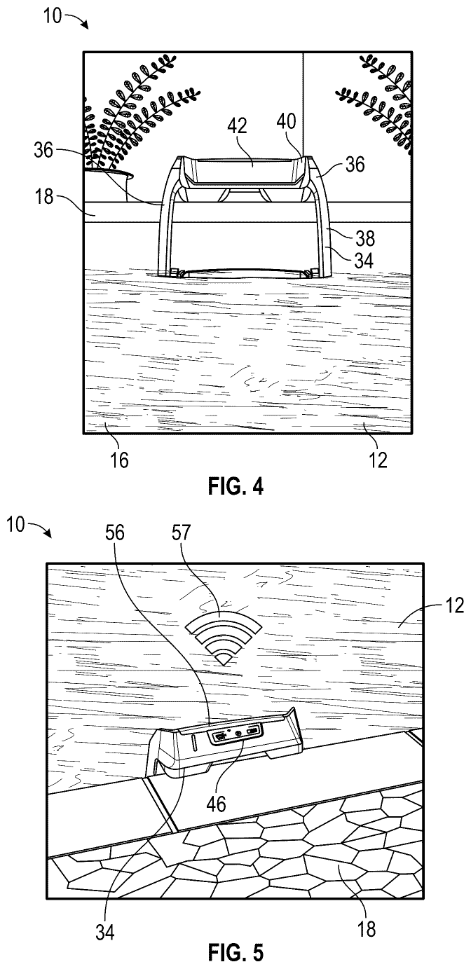

In certain embodiments, and as illustrated in FIGS. 3C and 4, for example, the arm assembly 34 optionally includes a transverse arm segment 42. The transverse arm segment 42 may extend in a side-to-side direction and/or outwards relative to a lateral side of the arm 36. The transverse arm segment 42 may further facilitate engagement of the arm assembly 34 with the surface and/or engagement by a user as desired. In embodiments where the arm assembly 34 includes a plurality of arms 36, the transverse arm segment 42 optionally connects adjacent arms 36 as illustrated in FIGS. 4, for example. In other embodiments, the pool cleaner 20 may include a plurality of disconnected arms 36, and at least one of the arms 36 includes a transverse arm segment 42.

As mentioned, the arm assembly 34 is movable relative to the body 22 between stowed and deployed configurations. In the deployed configuration, the arm assembly 34 extends forward relative to the body 22 of the pool cleaner 20. In the stowed configuration, the arm assembly 34 may be stored on, in, or proximate to the body 22 of the pool cleaner 20. By extending forward in the deployed configuration, the arm assembly 34 may be utilized to engage the ground surface 18 and support the pool cleaner 20 at the water line 16. Additionally, or alternatively, the arm assembly 34 in the deployed configuration may be utilized by a user to lift and/or transport the pool cleaner 20. Referring to FIGS. 9 and 10, the arm assembly 34 in the deployed configuration may facilitate removal of and/or access to a sub-component from the pool cleaner 20 (e.g., the front extraction filter 28 in FIG. 9) and/or removal of the entire pool cleaner 20 (see, e.g., FIG. 10).

In some embodiments, the arm assembly 34 may by automatically moved and/or may be manually moved as desired. In embodiments where the arm assembly 34 is automatically moved between the stowed configuration and the deployed configuration (and/or vice versa and/or to an intermediate position), the arm assembly 34 may be controlled responsive to a command from a user, based on information from a sensor, and/or responsive to various inputs or trigger events as desired. As non-limiting examples, the arm assembly 34 may be automatically deployed at the end of a cleaning cycle by the pool cleaner 20, based on a command or input received from a user on a user device or a remote device, based on a power status of an onboard power source, based on a filter status, based on a time of day, based on an operational schedule of the pool cleaner 20, based on a location of the pool cleaner 20 in the pool 12, combinations thereof, and/or as otherwise desired.

In addition to supporting the pool cleaner 20 and/or facilitating removal and/or transport of the pool cleaner 20, the arm assembly 34 may include one or more supplemental components 44 which may improve the functionality and/or operation of the pool cleaner 20. Such supplemental components 44 may be utilized in place of similar components on the pool cleaner 20 and/or in addition to similar components on the pool cleaner 20. In certain embodiments, the arm assembly 34 with the supplemental components 44 may provide improved modularity to the pool cleaner 20 (e.g., an arm assembly may be added to the cleaner 20 to have a desired set of supplemental components 44 without requiring replacement of the entire cleaner 20). Examples of supplemental components 44 are described in further detail below, but these examples should not be considered limiting, as arm assemblys 34 described herein may include additional types of supplemental components as desired and may be provided in various combinations or sub-combinations as desired. Moreover, the supplemental components 44 may be provided on various portions of the arm assembly 34 as desired, and the particular locations illustrated should not be considered limiting.

In some embodiments, and as illustrated in FIGS. 5-8, 16, and 18, for example, the supplemental component 44 may include a human machine interface 46 with one or more features 48 for providing information to a user 11 and/or for receiving information from the user 11. As non-limiting examples, the features 48 may include, but are not limited to, a display screen 50, a button 52, a speaker, a light 54, an indicator, combinations thereof, and/or as otherwise desired. Such features 48 may be utilized to receive and/or provide information as desired. As non-limiting examples, the display screen 50 may provide a battery status level, a filter status level, and/or other information as desired, the button 52 may receive a selection by the user 11, a characteristic of the light 54 (e.g., pattern, color, brightness, status, etc.) may be controlled to convey information, combinations thereof, and/or as otherwise desired.

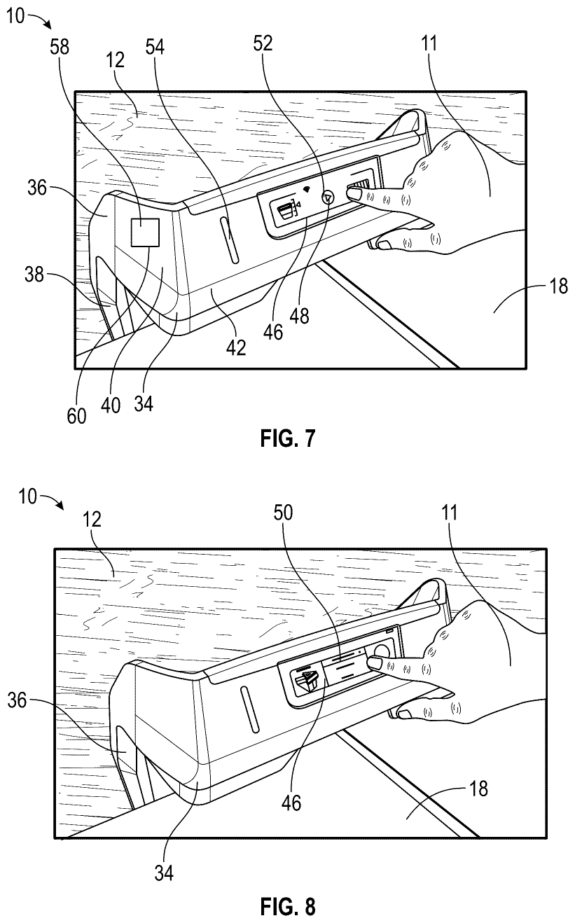

In some embodiments, and as illustrated in FIGS. 5-8, 16, and 18, the human machine interface 46 may be provided on the transverse arm segment 42. The human machine interface 46 on the transverse arm segment 42 may allow for the user 11 to engage the human machine interface 46 while the pool cleaner 20 remains within the pool (see, e.g., FIGS. 7 and 8), thereby improving engagement with the user 11. In other embodiments, the human machine interface 46 additionally or alternatively may be provided on other portions of the arm assembly 34 as desired, and the human machine interface 46 need not be on the transverse arm segment 42. In various embodiments, because the arm assembly 34 is movable relative to the body 22 of the pool cleaner 20, the human machine interface 46 also may be positioned at various positions and/or orientations as desired relative to the body 22.

In certain embodiments, and as illustrated in FIGS. 3B and 5, the supplemental component 44 may alternatively or additionally include an antenna 56 for the communication module of the pool cleaner 20 and enabling various wireless communication 57 (e.g., near field, cellular, Wi-Fi, Bluetooth®, Bluetooth Low Energy (BLE), low-power wide area network, cloud-based communication, combinations thereof, etc.). Similar to the human machine interface 46, the antenna 56 may be positioned at various positions or orientations as desired relative to the body 22 of the pool cleaner 20 by controlling movement of the arm assembly 34. In some embodiments, the antenna 56 may be utilized for wireless communication 57 while the arm assembly 34 is deployed and supporting the pool cleaner 20 at the water line 16. Additionally, or alternatively, the antenna 56 may be utilized for wireless communication when the arm assembly 34 is not deployed and/or the pool cleaner 20 is not at the water line 16. As a non-limiting example, in FIG. 3B, the arm assembly 34 is controlled to be at an intermediate position between the stowed configuration (FIG. 3A) and deployed configuration (FIG. 3C) and where the arm assembly 34 is at the water line 16 while the body 22 remains substantially submerged. In this embodiment, the pool cleaner 20 may wirelessly communicate using the antenna 56 while the pool cleaner 20 is otherwise in the water of the pool 12. In other embodiments, the antenna 56 may be utilized for other wireless communication as desired.

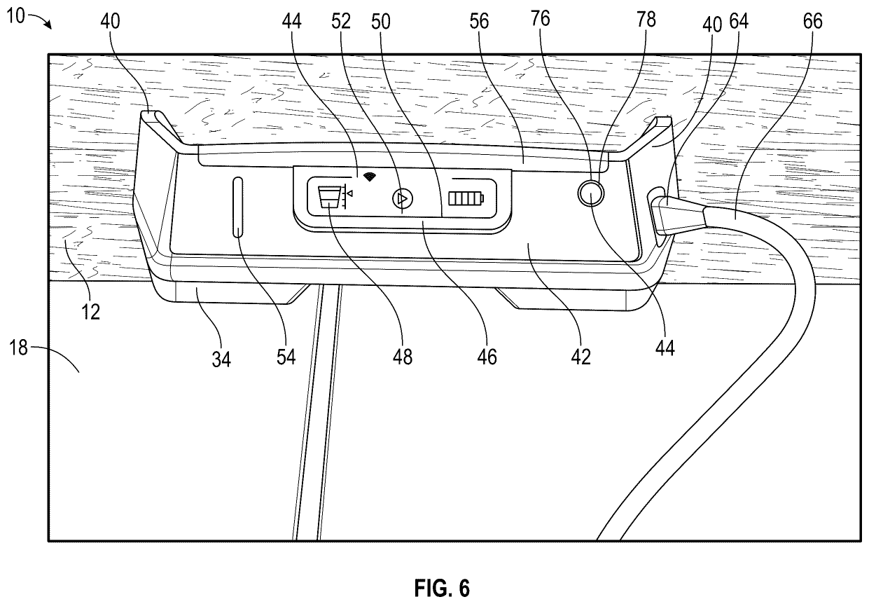

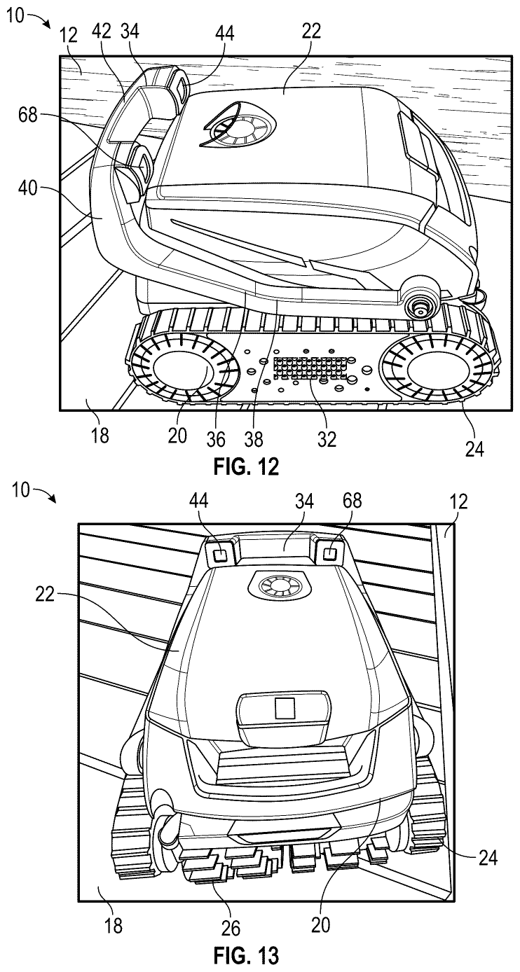

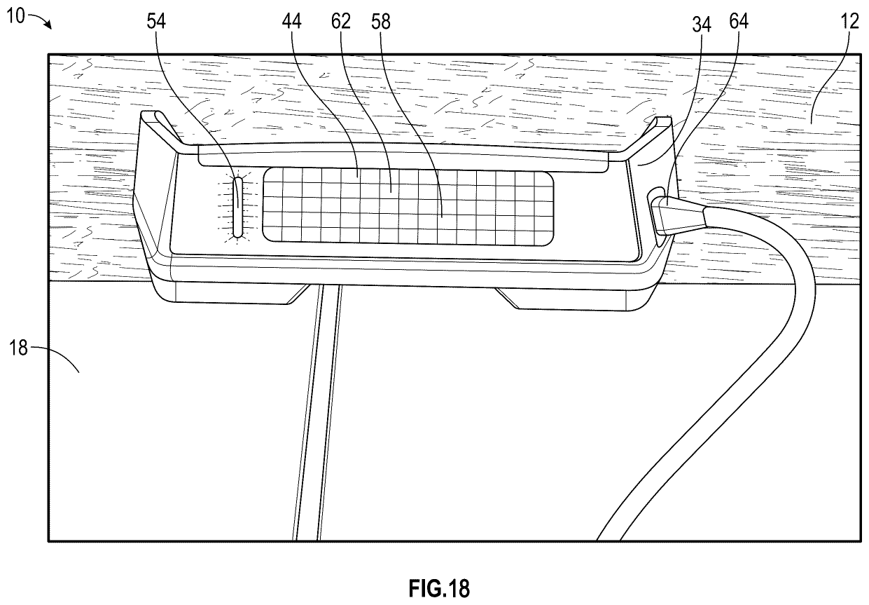

Additionally, or alternatively, the supplemental component 44 may include a powering component 58 associated with powering the pool cleaner and/or subcomponents thereof. Such powering components may include one or more devices for generating electrical energy, storing electrical energy, and/or receiving electrical energy from an external device or source. As non-limiting examples, the powering component 58 includes one or more removable and/or integrated batteries 60 as a store of electrical energy (see, e.g., FIG. 7), a solar panel 62 as a device generating electrical energy (see, e.g., FIG. 18), a charging port 64 configured to connect to and/or otherwise engage a charging cable 66 (see, e.g., FIG. 6), a charging pad or contact 68 (see, e.g., FIGS. 12 and 13), an induction charging component (e.g., coil), other charging features, combinations thereof, and/or other powering components as desired.

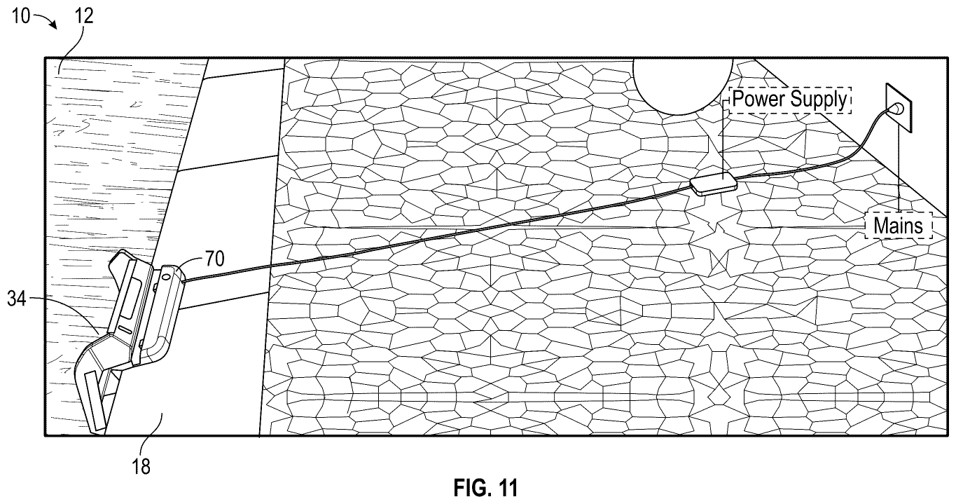

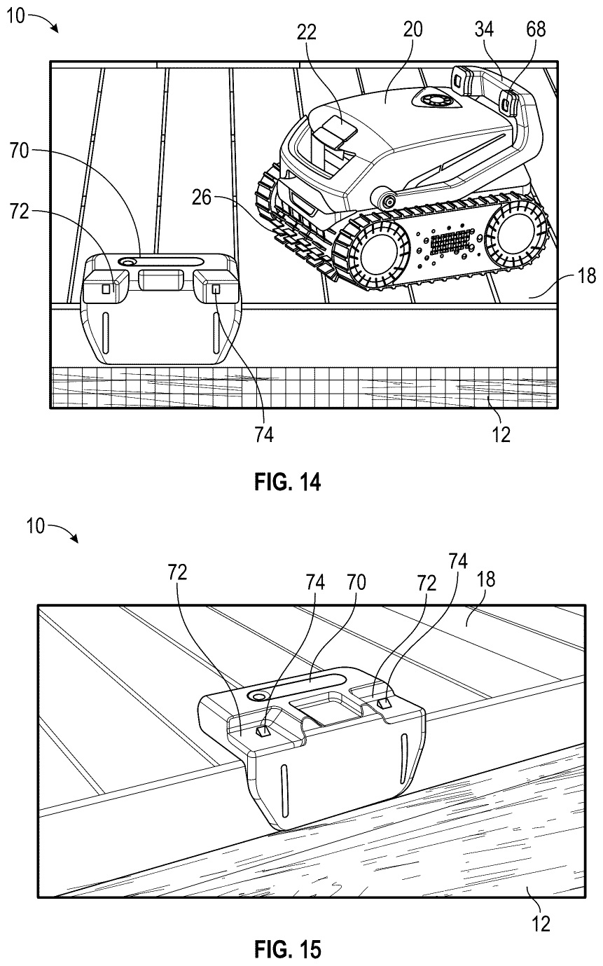

Referring to FIGS. 11 and 14-17, in embodiments where the arm assembly 34 includes a charging pad or contact 68 as a powering component 58, an arm assembly docking station 70 optionally may be provided with the pool system 10. The arm assembly docking station 70 may be connectable to an external power source (see, e.g., FIG. 11) and/or may include an onboard power source or store of energy, such as but not limited to a battery, a solar panel, combinations thereof, etc. (see, e.g., FIGS. 14-17). As illustrated in FIGS. 14-17, the arm assembly docking station 70 optionally includes one or more positioning features 72 for positioning and/or locating the arm assembly 34 relative to the arm assembly docking station 70. Optionally, such positioning features 72 may promote engagement between the charging pad or contacts 68 and charging connectors 74 of the arm assembly docking station 70. In certain embodiments, the arm assembly 34 may be utilized to facilitate lifting up onto the docking station 70. As a non-limiting example, the arm assembly 34 may be moved from a stowed configuration to a deployed configuration, and in the deployed configuration, the arm assembly 34 may move into engagement with the docking station. Optionally, the pool cleaner may further be controlled to facilitate engagement with the docking station 70. As a non-limiting example, in addition to the deployment of the arm assembly 34, the pool cleaner may propel itself upwards (e.g., by controlling a motive device 22, exhausting water from the outlet, etc.) such that the arm assembly 34 is above the docking station 70, and cessation of such propulsion may allow for the arm assembly 34 to lower into engagement with the docking station 70. Other controls (or combinations thereof) may be implemented to facilitate engagement with the docking station 70 as desired.

Referring to FIG. 6, the supplemental component 44 optionally includes one or more sensors 76. The sensors 76 may include various types of sensors as desired, such as but not limited to a camera, accelerometer, movement sensor, contact sensor, proximity sensor, water detection sensor, pressure sensor, light sensor, water sensor, temperature sensor, combinations thereof, and/or as otherwise desired. In the embodiment illustrated, the sensor 76 is a camera 78. The one or more sensors 76 may detect various information as desired, including information about the pool 12, water, an operating environment, a status of the arm assembly 34, a status of the pool cleaner 20, combinations thereof, and/or other information as desired. In certain embodiments, the one or more sensors 76 may be positioned to be at various positions or locations relative to the body 22 as desired by positioning the arm assembly 34. As a non-limiting example, the position or orientation of the camera 78 as the sensor 76 may be controlled to point or aim at the pool 12. The one or more sensors 76 on the arm assembly 34 may be positioned to be at various locations relative to the body by causing movement of the arm assembly as desired, which may provide an improved ability by the sensors to obtain various information.

In some embodiments, information obtained by the one or more sensors 76 may be utilized to control operation of the pool cleaner 20 and/or the arm assembly 34. As a non-limiting example, the sensor(s) 76 may detect and/or determine an end of the cleaning cycle and/or the position of the pool cleaner 20, and the arm assembly 34 may be automatically stowed or deployed based on such data. As another non-limiting example, a sensor 76 may detect vertical movement of the pool cleaner 20 and a removal of contact by a user, and based on such sensor data, the arm assembly 34 may automatically move to the stowed configuration. As another non-limiting example, responsive to the filter 28 being full as detected by a sensor 76, the arm assembly 34 may be automatically deployed and/or a feature of the human machine interface 46 may be controlled to provide an alert to a user.

Additionally, or alternatively, the arm assembly 34 optionally may include one or more features of a hydraulic circuit of the pool cleaner 20. As a non-limiting example, the arm assembly may include the filter 28 for capturing debris and/or the arm assembly 34 may be integrated with the filter 28 of the pool cleaner 20. As one non-limiting examples, the arm assembly 34 may be integrated with a front extraction filter 28 of the pool cleaner 20.

Various other controls may be implemented as desired, and the aforementioned examples should not be considered limiting. Various other combinations of features may be utilized as desired, and the aforementioned examples should not be considered limiting.

Exemplary concepts or combinations of features of the invention may include:
A. A pool cleaner comprising a body and an arm assembly, wherein the arm assembly is connected to the pool cleaner such that the arm assembly is movable between a stowed configuration and a deployed configuration, and wherein the arm assembly comprises a human machine interface.
B. The pool cleaner of any preceding or subsequent statement or combination of statements, wherein the arm assembly is pivotable, rotatable, slidable, and/or linearly movable relative to the pool cleaner between the deployed and stowed configurations.
C. The pool cleaner of any preceding or subsequent statement or combination of statements, wherein the human machine interface comprises one or more of a screen, a button, a light, a microphone, a camera, a projector, or a speaker.
D. A pool cleaner comprising a body and an arm assembly, wherein the arm assembly is movably connected to the pool cleaner such that the arm assembly is movable between a stowed configuration and a deployed configuration, and wherein the arm assembly comprises an antenna for wireless communication.
E. A pool cleaner comprising a body and an arm assembly, wherein the arm assembly is movably connected to the pool cleaner such that the arm assembly is movable between a stowed configuration and a deployed configuration, and wherein the arm assembly comprises a sensor.
F. The pool cleaner of any preceding or subsequent statement or combination of statements, wherein the sensor comprises a battery.
G. A pool cleaner comprising a body and an arm assembly, wherein the arm assembly is movably connected to the pool cleaner such that the arm assembly is movable between a stowed configuration and a deployed configuration, and wherein the arm assembly comprises a powering component.
H. The pool cleaner of any preceding or subsequent statement or combination of statements, wherein the powering component comprises a power source.
I. The pool cleaner of any preceding or subsequent statement or combination of statements, wherein the power source comprises a solar panel.
J. The pool cleaner of any preceding or subsequent statement or combination of statements, wherein the powering component comprises at least one battery.
K. The pool cleaner of any preceding or subsequent statement or combination of statements, wherein the powering component further comprises a charging component.
L. The pool cleaner of any preceding or subsequent statement or combination of statements, wherein the charging component comprises a charging port.
M. The pool cleaner of any preceding or subsequent statement or combination of statements, wherein the charging component comprises a charging connector or pad.
N. The pool cleaner of any preceding or subsequent statement or combination of statements, further comprising an arm assembly docking station, wherein the arm assembly is configured to engage the arm assembly docking station.
O. The pool cleaner of any preceding or subsequent statement or combination of statements, wherein the arm assembly docking station further comprises a charging connector.
P. The pool cleaner of any preceding or subsequent statement or combination of statements, wherein the arm assembly docking station further comprises a solar panel.
Q. A pool cleaner comprising: a body; and an arm assembly, wherein the arm assembly is connected to the pool cleaner such that the arm assembly is movable between a stowed configuration and a deployed configuration, wherein the arm assembly comprises a supplemental component providing supplemental functionality to the arm assembly.
R. The pool cleaner of any preceding or subsequent statement or combination of statements, wherein the supplemental component comprises a human machine interface.
S. The pool cleaner of any preceding or subsequent statement or combination of statements, wherein the arm assembly is rotatable between the stowed configuration and the deployed configuration.
T. The pool cleaner of any preceding or subsequent statement or combination of statements, wherein the supplemental component comprises an antenna for wireless communication.
U. The pool cleaner of any preceding or subsequent statement or combination of statements, wherein the supplemental component comprises a sensor.
V. The pool cleaner of any preceding or subsequent statement or combination of statements, wherein the supplemental component comprises a powering component.
W. The pool cleaner of any preceding or subsequent statement or combination of statements, further comprising a front extraction filter, wherein the front extraction filter is removable from the pool cleaner at least when the arm assembly is in the deployed configuration.
X. A pool system comprising: the pool cleaner of any preceding or subsequent statement or combination of statements and an arm assembly docking station configured to engage the arm assembly in the deployed configuration.
Y. The pool system of any preceding or subsequent statement or combination of statements, wherein the arm assembly docking station further comprises a charging connector.
Z. The pool cleaner of any preceding or subsequent statement or combination of statements, wherein the arm assembly docking station further comprises a solar panel.
AA. A pool cleaner comprising: a body; and an arm assembly comprising an end connected to the pool cleaner such that the arm assembly is movable between a stowed configuration and a deployed configuration, wherein a portion of the arm assembly opposite from the end comprises a supplemental component providing supplemental functionality to the arm assembly.
BB. The pool cleaner of any preceding or subsequent statement or combination of statements, wherein the supplemental component comprises one or more of: a human machine interface; an antenna; a sensor; or a powering component.
CC. The pool cleaner of any preceding or subsequent statement or combination of statements, wherein, in the deployed configuration of the arm assembly, the human machine interface is spaced apart from the body of the pool cleaner.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although devices and techniques have been described for use principally with pool cleaners, the features described herein may be utilized in connection with other objects and in other manners. Finally, references to “pools” and “swimming pools” herein may also refer to spas or other water containing vessels used for recreation, training, or therapy and for which cleaning of debris is needed or desired.

That which is claimed:

1. A pool cleaner comprising:
a body; and
an arm assembly,
wherein the arm assembly is connected to the pool cleaner such that the arm assembly is movable between a stowed configuration and a deployed configuration, wherein, in the deployed configuration, the arm assembly extends forward from a front end of the body, and wherein the arm assembly comprises a supplemental component providing supplemental functionality to the arm assembly.

2. The pool cleaner of claim 1, wherein the supplemental component comprises a human machine interface.

3. The pool cleaner of claim 2, wherein the human machine interface comprises one or more of a screen, a button, a light, a microphone, a camera, a projector, or a speaker.

4. The pool cleaner of claim 1, wherein the arm assembly is rotatable between the stowed configuration and the deployed configuration.

5. The pool cleaner of claim 1, wherein the supplemental component comprises an antenna for wireless communication.

6. The pool cleaner of claim 1, wherein the supplemental component comprises a sensor.

7. The pool cleaner of claim 1, wherein the supplemental component comprises a powering component.

8. The pool cleaner of claim 7, wherein the powering component comprises a power source.

9. The pool cleaner of claim 8, wherein the power source comprises a solar panel.

10. The pool cleaner of claim 7, wherein the powering component comprises at least one battery.

11. The pool cleaner of claim 7, wherein the powering component comprises a charging component.

12. The pool cleaner of claim 11, wherein the charging component comprises one or more of a charging port, a charging connector, or a charging pad.

13. The pool cleaner of claim 1, further comprising a front extraction filter, wherein the front extraction filter is removable from the pool cleaner at least when the arm assembly is in the deployed configuration.

14. A pool system comprising:
the pool cleaner of claim 1; and
an arm assembly docking station configured to engage the arm assembly in the deployed configuration.

15. The pool system of claim 14, wherein the arm assembly docking station further comprises a charging connector.

16. The pool system of claim 14 wherein the arm assembly docking station further comprises a solar panel.

17. A pool cleaner comprising:
a body; and
an arm assembly comprising an end connected to the pool cleaner such that the arm assembly is movable between a stowed configuration and a deployed configuration, wherein a portion of the arm assembly opposite from the end comprises a supplemental component providing supplemental functionality to the arm assembly.

18. The pool cleaner of 17, wherein the supplemental component comprises one or more of:
a human machine interface;
an antenna;
a sensor, or
a powering component.

19. A pool cleaner comprising:
a body; and
an arm assembly connected to the pool cleaner such that the arm assembly is movable between a stowed configuration and a deployed configuration, wherein the arm assembly comprises a human machine interface.

20. The pool cleaner of claim 19, wherein, in the deployed configuration of the arm assembly, the human machine interface is spaced apart from the body of the pool cleaner.
